(19) United States
(12) Patent Application Publication
(10) Pub. No.: US 2014/0143859 A1
(43) Pub. Date: May 22, 2014

(54) UNLOCK TOUCH SCREEN USING TOUCH PASSWORD

(71) Applicants: Mario Linge, Hillview, CA (US); Yang-cheng Fan, San Jose, CA (US)

(72) Inventors: Mario Linge, Hillview, CA (US); Yang-cheng Fan, San Jose, CA (US)

(21) Appl. No.: 13/679,172

(22) Filed: Nov. 16, 2012

(51) Int. Cl. G06F 21/36

(52) U.S. Cl. CPC G06F 21/36
USPC 726/19

(57) ABSTRACT

A method for unlocking a touch screen includes: in response to tapping by a user on a screen, receiving a time sequence of data samples representing the tapping by the user; comparing the time sequence of data samples with a stored data samples to determine if the time sequence of data samples matches the stored data samples; if there is a match, unlocking, the screen; and if there is no match, notifying the user.

### FIELD OF THE INVENTION

The present disclosure is directed to a method and system for gaining access to a device, in particular, to using tapping patterns to unlock a touch screen of a mobile device.

### BACKGROUND

To protect the content stored in a device such as a computer, the display screen of the device is commonly set up so that it is automatically locked or logged out after a period of inactivity. Also, a user may manually lock the screen or log out a device. This may be especially true for mobile devices that run business applications because business applications with critical data need special protection from access by unauthorized third-party individuals for these mobile devices are easy to lose.

After a device is locked (or logged out), the user needs to unlock (or log into) the screen to regain access to the device. For a mobile device that has a touch screen, the user may need to enter a password to unlock (or log into) the screen. For example, the user may slide on a touch screen of the mobile device to bring up a display of entry fields and a soft keyboard of alphabets and numerals. Thereafter, the user may enter a password for unlocking or login. If the password matches the previously selected password stored in the device, the screen is unlocked. However, if the password does not match, the screen will not be unlocked, and the user may need to try again. The current art for unlocking a screen requires the user to view the screen (or the keyboard) to enter the password. The problem with current art is that it lacks privacy because the entered password may be visible to others while the user enters it.

Another problem with current art is that to have a secured password, the password needs certain complexity. For the password of alphabets and numerals, the password may need to exceed certain length to comply with the security requirement. If the password is a drawing pattern, the drawing pattern may need to include at least a certain number of strokes. Therefore, the more secure the password is, the longer time it may take to unlock the screen. Further, the more complex password may be easier to be forgotten by the user. The recovery of forgotten passwords may incur additional costs.

### BRIEF DESCRIPTION OF THE DRAWINGS

FIG. 1 is a mobile device according to an embodiment of the present disclosure.

FIGS. 2A-B are example time sequences of data samples according to an embodiment of the present disclosure.

FIG. 3 is an touch screen that is divided into four quadrants according to an embodiments of the present disclosure.

FIG. 4 is an example time sequence of data samples including location information according to an embodiment of the present disclosure.

FIG. 5 is a process of unlocking a touch screen according to an embodiment of the present disclosure.

### DETAILED DESCRIPTION

As more and more mobile devices are equipped with touch screens, more private and more secure unlock mechanism may be desirable. Rather than using visual passwords (i.e., alphanumerical passwords or drawing patterns), embodiments of the present disclosure may use rhythmic patterns of touches as the password to unlock (or log into) a device. For the convenience of discussion, the following refers to only unlocking a device, which should be understood to include both unlocking a screen and logging into a device from which a user has been logged out. We may call the rhythmic pattern a “touch password.” In a preferred embodiment, in response to a user tapping or drumming a certain rhythm on a touch screen of a mobile, a processor may capture the taps as a time sequence of data samples. The processor may further compare the captured time sequence with a pre-recorded time sequence of tapping with respective to the user to determine if there is a match. If the captured taps match the pre-recorded taps, the processor may unlock the screen. However, if the captured taps does not match the pre-recorded taps, the processor may display an error message indicating that password does not match. The rhythm of the tapping may be based on user's creation, or based on a portion of a certain music (or song) rhythm that the user is familiar with, or simply based on a certain frequency.

Embodiments of the present disclosure may include a device that includes a screen, a sensor for receiving tapping by a user, and processor configured to (1) receive a time sequence of data samples representing the tapping by the user, (2) compare the time sequence of data samples with stored data samples to determine if the time sequence of data samples matches the stored data samples, (3) if there is a match, unlock the touch screen; and (4) if there is no match, notify the user.

Embodiments of the present disclosure may include a method that includes in response to tapping by a user on a screen, receiving a time sequence of data samples representing the tapping by the user, comparing the time sequence of data samples with stored data samples to determine if the time sequence of data samples matches the stored data samples, if there is a match, unlocking the touch screen, and if there is no match, notifying the user.

Embodiments of the present disclosure may include a mobile device including a touch screen, a touch sensor, and a processor that is configured to unlock the touch screen based on a rhythmic pattern of a user tapping on the touch sensor.

Embodiments of the present disclosure may include a method for unlocking a touch screen including unlocking the touch screen based on a rhythmic pattern of a user tapping on a touch sensor embedded in the touch screen.

Compared with current art of visual password entry, the touch password may have the advantage that a user may enter a touch password without the view of the touch screen. For example, the user may try to unlock a mobile device (such as a smart phone) in his pocket without taking the device out. In this way, the user may protect the password from visible views and therefore stolen. Also, since taps are not alphabets or numbers, they are in a sense more secure than the password of current art.

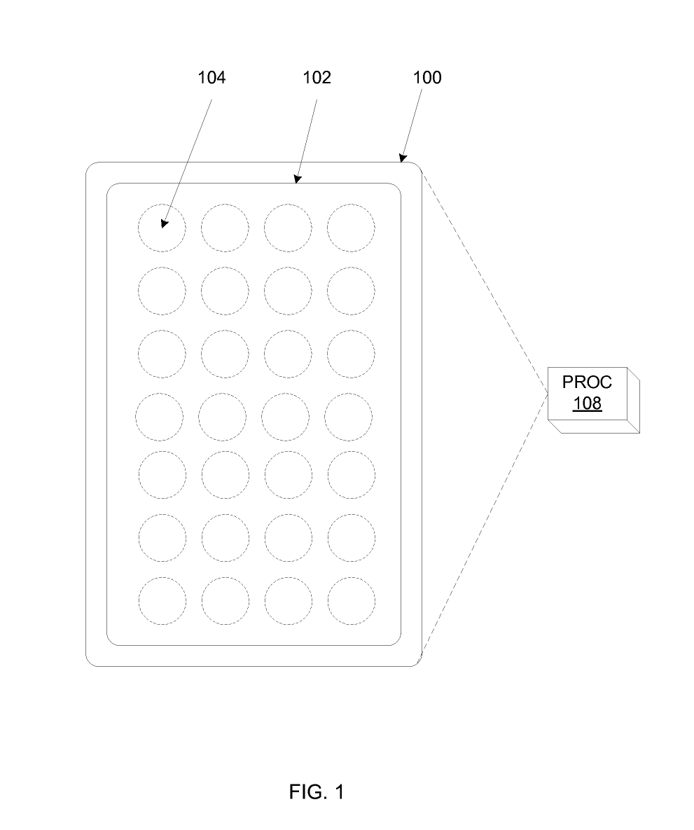

FIG. 1 is a mobile device that includes a touch screen according to an embodiment of the present disclosure. The mobile device 100 may include a touch screen 102, an array of touch sensors 104, a processor 106, and a memory 108. The touch screen 102 may include a display layer (such as a LED display) that may be used as a graphic user interface (GUI) for displaying contents. For example, the display layer may display soft keyboard and an interface for prompting password entry. The array of sensors 104 may be a two-dimensional array of capacitive sensors. The location of each sensors may be pre-specified with a coordinate so that when a user touches the touch screen, a particular sensor may be activated and send out an electronic pulse.

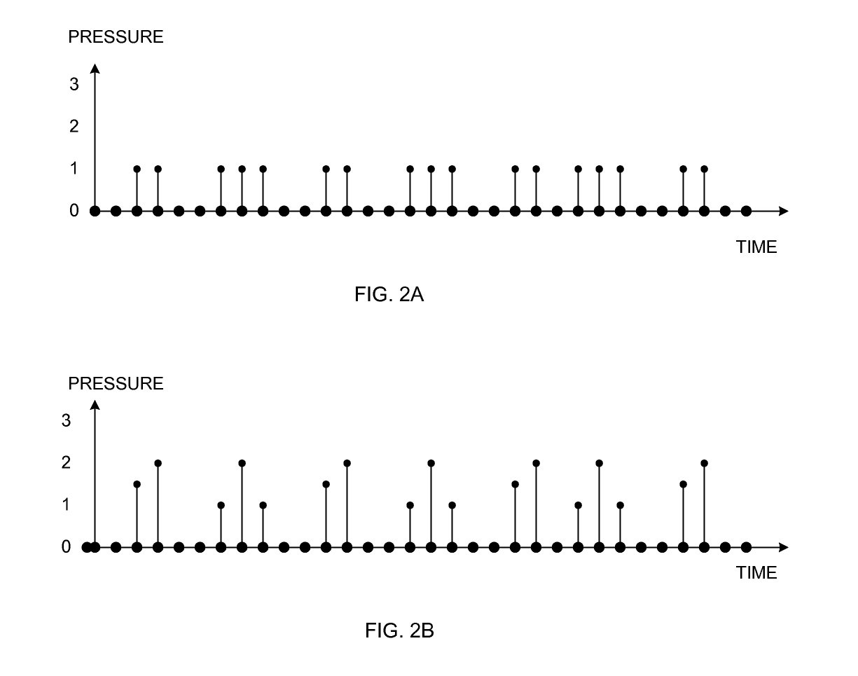

A sampling circuit (not shown) may sample the electronic pulses generated from the array of sensors because of users' taps. In one embodiment, the sampling circuit may uniformly sample the array of touch sensors at a fixed sampling rate. FIG. 2A shows example a time sequence of data samples sampled from the electronic pulses at the array of touch sensors 104 according to an embodiment of the present disclosure. For this particular example, the sampling circuit is only concerned with the occurrences of taps on the array of touch sensors rather than the strength of the tap or where it occurs. Therefore, the array of touch sensors may be treated as a single sensor. As shown in FIG. 2A, when the sampling circuit captures an electronic pulse at a time instance, the data sample at that time may have amplitude one. When the sampling circuit does not capture any electronic pulse at a time instance, the sample at that time has amplitude zero. In practice, the sampling rate of the sampling circuit may be much higher than the frequency of the occurrences of the electronic pulses to ensure the capture of all electronic pulses. Processor 106 may continuously receive the time sequence of data samples from the sampling circuit.

Further, processor 106 may be programmed to calculate a characteristic of the tapping of the touch screen. The characteristic may be a pattern that may uniquely identify the particular tapping. In one example, the characteristic may be the rhythm of the tapping which may be calculated by the processor 106 based on the time sequence captured from the array of touch sensors. Alternatively, the characteristic of tapping may be mathematically derived from the time sequence of data samples, or quantities as a function of the time sequence of data samples. In one embodiment, the processor may be configured to measure the time differences between consecutive taps. For example, the time differences may be measured by counting how many “zero” samples between two consecutive “one” samples. In another embodiment, the characteristic may be one or more statistical quantities of the time sequence of data samples, including mean and variations of the time sequence. In another embodiment, frequency transformation (such as Fourier transform, short-time Fourier transform, or wavelet transform) may be applied to the time sequence, a frequency characteristic of the tapping may be calculated in the frequency domains.

In a setup stage, an example of the user tapping may be pre-recorded and stored in the memory 108 as the password for unlocking the mobile device. The example tapping may be similarly captured as a time sequence and stored as the touch password data. Thus, when later the user taps the touch screen to unlock the screen, processor 106 may receive the time sequence of tapping and compare the newly captured time sequence against the stored time sequence to determine if there is a match. In one embodiment, the processor 106 may be configured to execute a comparison module to directly compare the two time sequences based on a comparing algorithm. Alternatively, the processor 106 may first calculate a first characteristic value for the captured time sequence and a second characteristic value for the stored time sequence. Then, the processor 106 may be configured to execute the comparison module to compare the two characteristics to determine if there is a match. Processor 106 may issue an instruction to unlock the screen if there is a match.

For certain situations, the calculated characteristics of the time sequence may identify the essence of the tapping and is thus superior to the direct comparison of the captured time sequence and recorded time sequence. For example, although the rhythm of the captured tapping is substantially identical to the pre-recorded one, the speed (or the beat) of the captured tapping may be different from the pre-recorded one. If the captured tapping for unlocking the touch screen is slower than the pre-recorded one, the captured time sequence is a stretch-out version of the pre-recorded one. On the other hand, if the captured tapping for unlocking the touch screen is faster than the pre-recorded one, the captured time sequence is a compressed version of the pre-recorded one. In either case, a direct comparison of the captured and pre-recorded time sequence may not yield a match of the touch password. However, instead of the direct comparison of time sequences, a characteristic of the time sequences is used for comparing the touch password. The speed problem may be resolved. For example, a frequency characteristic may eliminate the speed difference between the captured time sequence and the pre-recorded time sequence, and determine a match based on the substantially identical rhythm of the two time sequences.

In the above discussion, the touch sensors 104 detect when a tapping (or touches) on the touch screen occurs. Therefore, as shown in FIG. 2A, the time sequence includes only ones and zeros. However, in other embodiments, the touch sensors 104 may be capable of detecting not only the timing of tapping, but also the pressures applied to the touch screen. Therefore, the touch sensors 104 may send out electronic pulses of different magnitudes indicating the different pressures applied to the touch screen by the user's finger. The sampling circuit may then sample and quantize the sequence of electronic pulses, and convert the electronic pulses into a time sequence of digital samples. FIG. 2B is an example time sequence of digital signals that includes the pressure information. Compared to the time sequence as shown in FIG. 2A, the time sequence of FIG. 2B has varying amplitudes that encode the strength of taps by the user. Thus, processor 106 may compare the captured time sequence of tapping with the pre-recorded time sequence (which may also be recorded with tap strength information) based not only on the timing of tap occurrences, but also on the strengths of each tap.

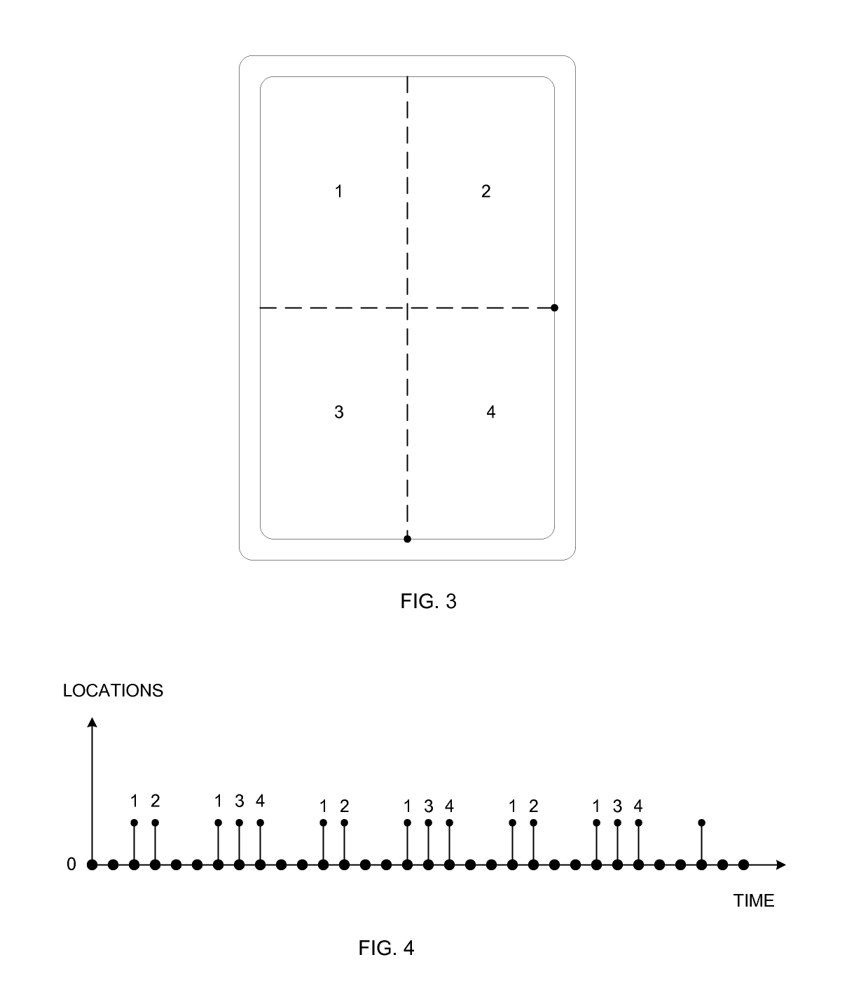

In another embodiment, the sampling circuit may capture the spatial information of tapping. Each touch sensor in the array 104 may be associated with a geographical coordinate. The sampling circuit may record not only the time of the occurrence of a tap, but also where on the touch screen the tap took place. Therefore, the time sequence may also include the location information of taps. For example, in a non-limiting example, the array of touch sensors may be divided into four quadrants (1, 2, 3, 4) as shown in FIG. 3 The time sequence as shown in FIG. 4 at each data point may include an additional quantity to indicate where tapping took place. Subsequently, processor 106 may compare the captured time sequence of tapping with the pre-recorded time sequence (which may also be recorded with the tap location information) based not only on the timing of tap occurrences, but also on the location information of each tap. The location of tapping may also be related to the fingers of the user. For example, if the user uses more than one finger to tap, the relative positions of where taps occur may determine which finger is associated with a tap. This information may also be used to identify a touch password.

In an alternative embodiment, the sampling circuit may capture all factors—timing, strength, location, and finger—of tapping in a time sequence, and processor 106 may determine if there is a match with the stored password taking into consideration all these factors.

Embodiments of the present disclosure may place certain further requirements on the touch passwords to enhance their robustness and security. In one embodiment, the number of taps may be pre-determined and is known to processor 106. Thus, processor 106 may specify a window for capturing data samples from the sampling circuit. The window may be at least as long as the pre-determined number. In one embodiment, processor 106 may continuously monitor the sampling circuit to determine if a touch password has occurred. In this scenario, the window is a sliding window that is shifted with time. In another embodiment, processor 106 may be in a sleeping mode and is awake only in response to a wake-up signal. For example, a wake-up signal may be a pre-determined number of consecutive taps by the user on the touch screen. In response to a wake-up signal, processor 106 may start to monitor the sampling circuit and receive the time sequence from the sampling circuit.

In one embodiment, for security reasons, when a user sets up the touch password, the touch password is required to have a minimum number of taps. For example, the minimum number of taps may be set at 8 or more taps. In another embodiment, the touch password may require certain level of complexity. For example, the device may prohibit the user to set up a password of all 1's.

While embodiments of the present disclosure are discussed in view of the mobile device as shown in FIG. 1, the touch password is not limited to the specific embodiment. In fact, the touch password may be used in devices that have a touch sensor.

In one embodiment, the touch password may be stored in the cloud or a server that is communicatively connected to the mobile device through a network. Thus, the mobile device may capture the time sequence of data samples indicating the tapping on the touch screen and transmit the time sequence to the cloud or server. A processor in the cloud or the server may compare the received time sequence with a time sequence stored in the cloud or server, representing the touch password to determine if there is a password match. Based on the determination, the cloud or server may transmit a permission or denial to the mobile device for unlocking the screen. To increase the transmission security, the mobile device and the cloud (or server) may both include encryption and decryption modules that may encrypt data transmitted between the mobile device and the cloud (or server).

Therefore, embodiments of the present disclosure may include a processor that is configured to receive a time sequence of data samples that was captured by a touch sensor indicating taps on a touch screen, compare the time sequence of data samples with a stored sequence of data sample to determine if there is a match, and if there is a match, unlock the screen. The captured time sequence of data samples may encode at least one of time of tapping on the touch screen, tap pressures applied to the touch screen, and locations at which the taps occurred.

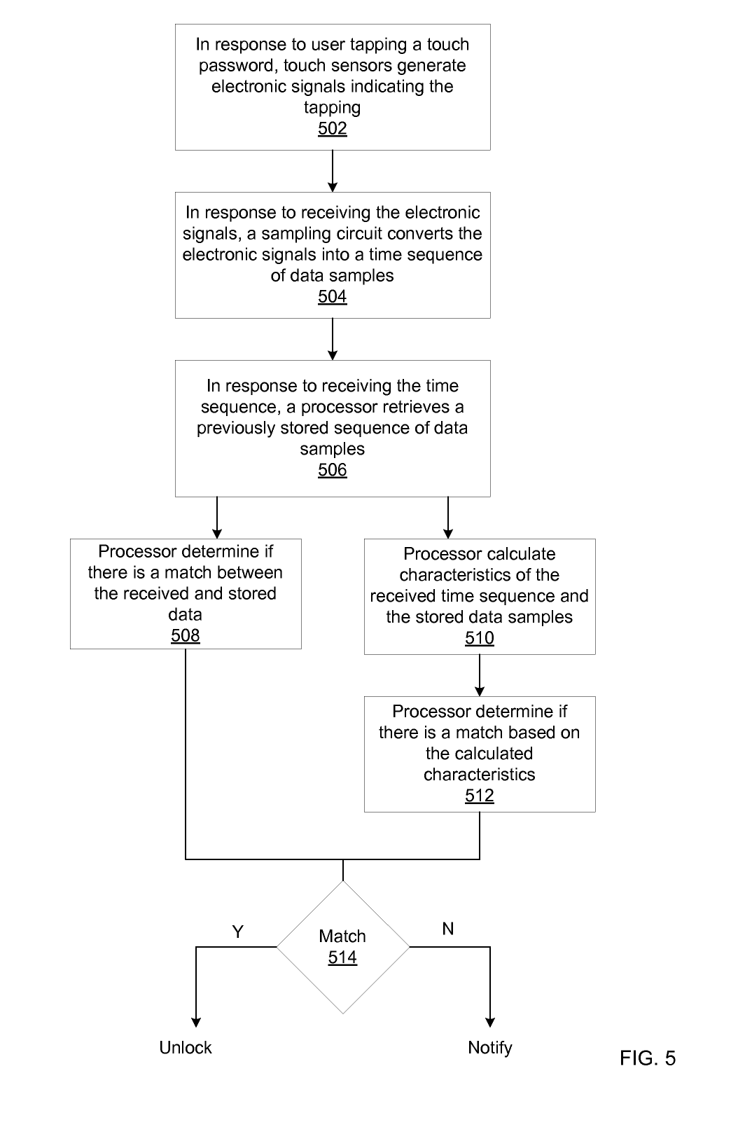

FIG. 5 is a process of matching touch password according to an embodiment of the present disclosure. At 502, an array of touch sensors embedded underneath a touch screen may generate electronic pulses in response to a user tapping on the touch screen. At 504, a sampling circuit may receive the electronic pulses from the array of touch sensors and convert the received electronic pulses into a time sequence of data samples. The time sequence of data samples may include the information of when tapping the touch screen occurs, the pressure of the tapping as applied to the touch screen, and/or the locations at which the tapping occurs. At 506, a processor may receive the time sequence of data samples from the sampling circuit and retrieve a previously stored sequence of data from a storage device. In one embodiment, at 508, the processor may execute a comparison module to compare the just received time sequence of data samples against the stored sequence of data to determine if there is a match for the touch password. In an alternative embodiment, at 510, the processor may be configured to calculate one or more characteristics of the just received time sequence of data samples. At 510, the processor may also be configured to calculate one or more characteristics of the stored sequence of data. At 512, the processor may be configured to compare the one or more characteristics of the just received time sequence of data samples and the stored sequence of data to determine if there is a match for the touch password. At 514, if there is a match for the touch password, the processor may be configured to unlock the screen. On the other hand, if there is no match for the touch password, the processor may be configured to display a notice on the touch screen to the user.

Although the present disclosure has been described with reference to particular examples and embodiments, it is understood that the present disclosure is not limited to those examples and embodiments. Further, those embodiments may be used in various combinations with and without each other. The present disclosure as claimed therefore includes variations from the specific examples and embodiments described herein, as will be apparent to one of skill in the art.

We claim:

1. A device, comprising:
a processor for
receiving a time sequence of data samples representing tapping by the user on a touch sensor embedded in a touch screen;
comparing the time sequence of data samples with stored data samples to determine if the time sequence of data samples matches the stored data samples;
if there is a match, unlocking the touch screen; and
if there is no match, notifying the user.

2. The device of claim 1, further comprising:
a sampling circuit for converting the tapping by the user into the time sequence of data samples.

3. The device of claim 1, wherein the screen includes a touch screen, and the sensor includes an array of touch sensors.

4. The device of claim 3, wherein the time sequence of data samples include information of at least one of when the tapping by the user occurs, amount of tapping pressure by the user applied to the touch screen, and locations at which the tapping by the user takes place.

5. The device of claim 4, wherein the processor is further configured to compute one or more characteristics of the time sequence of data samples and one or more characteristics of the stored data samples, and compare the one or more characteristics of the time sequence of data samples with the one or more characteristics of the store data samples to determine if there is a match.

6. The device of claim 5, wherein the one or more characteristics include time differences between two consecutive taps by the user on the touch screen.

7. The device of claim 5, wherein the one of more characteristics include statistical characteristics.

8. The device of claim 5, further comprising:
transforming the time sequence of data samples and the stored data samples into a frequency domain;
calculating the one or more characteristics in the frequency domain.

9. The device of claim 5, wherein the one or more characteristics include rhythm of the user tapping.

10. The device of claim 1, wherein the stored data samples are data samples representing tapping of user at a setup stage.

11. The device of claim 1, wherein the time sequence of data samples does not include a selection of alphabets or numbers.

12. The device of claim 1, wherein the unlocking includes a login process for the user.

13. A computer-implemented method of unlocking a screen, comprising:
in response to tapping by a user on a screen, receiving, by a processor, a time sequence of data samples representing the tapping by the user;
comparing, by the processor, the time sequence of data samples with a stored data samples to determine if the time sequence of data samples matches the stored data samples;
if there is a match, unlocking, by the processor, the screen; and
if there is no match, notifying, by the processor, the user.

14. The method of claim 13, wherein the screen includes a touch screen, and the sensor includes an array of touch sensors.

15. The method of claim 14, wherein the time sequence of data samples include information of at least one of when the tapping by the user occurs, amount of tapping pressure applied by the user to the touch screen, and locations at which the tapping by the user takes place.

16. The method of claim 15, further comprising:
computing one or more characteristics of the time sequence of data samples and one or more characteristics of the stored data samples, and
comparing the one or more characteristics of the time sequence of data samples with the one or more characteristics of the store data samples to determine if there is a match.

17. The method of claim 16, wherein the one or more characteristics include time differences between two consecutive taps by the user on the touch screen.

18. The method of claim 16, wherein the one of more characteristics include statistical characteristics.

19. The method of claim 16, further comprising:
transforming the time sequence of data samples and the stored data samples into a frequency domain;
calculating the one or more characteristics in the frequency domain.

20. A machine-readable non-transit storage medium having stored thereon executable codes that when executed, perform a method of unlocking a screen, the method comprising:
in response to tapping by a user on a screen, receiving a time sequence of data samples representing the tapping by the user;
comparing the time sequence of data samples with a stored data samples to determine if the time sequence of data samples matches the stored data samples;
if there is a match, unlocking the touch screen; and
if there is no match, notifying the user.
